(19) United States
(12) Patent Application Publication
(10) Pub. No.: US 2025/0216334 A1
(43) Pub. Date: Jul. 3, 2025

(54) FIELD QUANTITATIVE ANALYSIS METHOD AND SYSTEM OF LITHIUM

(71) Applicant: INSTITUTE OF GEOLOGY AND GEOPHYSICS, CAS, Beijing (CN)

(72) Inventors: Zhiyuan LI, Beijing (CN); Kezhang QIN, Beijing (CN); Ziye YU, Beijing (CN); Kai KANG, Beijing (CN); Xingwang XU, Beijing (CN)

(21) Appl. No.: 18/660,637

(22) Filed: May 10, 2024

(30) Foreign Application Priority Data
Dec. 28, 2023 (CN) 202311835597.7

(51) Int. Cl. G01N 21/71

(52) U.S. Cl. CPC G01N 21/718; G01N 2201/06113; G01N 2201/12784

(57) ABSTRACT

The present disclosure provides a field quantitative analysis method and system of lithium, and relates to the technical field of field quantitative analysis of lithium. The method includes: measuring a laser-induced breakdown spectroscopy of a lithium-containing mineral, to obtain spectral data of the lithium-containing mineral; taking the spectral data as an input, and determining a mineral class of the lithium-containing mineral based on a trained mineral classification model; and taking the spectral data as the input, and determining content of lithium in the lithium-containing mineral based on a calibration curve corresponding to the mineral class.

### CROSS REFERENCE TO RELATED APPLICATION

This patent application claims the benefit and priority of Chinese Patent Application No. 202311835597.7, filed with the China National Intellectual Property Administration on Dec. 28, 2023, the disclosure of which is incorporated by reference herein in its entirety as part of the present application.

### TECHNICAL FIELD

The present disclosure relates to the technical field of field quantitative analysis of lithium, and in particular to a field quantitative analysis method and system of lithium.

### BACKGROUND

Lithium resources are important strategic mineral resources in China. Because lithium is an ultralight element, field quantitative analysis of lithium has been a difficult task. At present, quantitative analysis of ultralight elements can be implemented through only a laser-induced breakdown spectroscopy (LIBS) technology. Through the LIBS technology, plasmas can be excited by irradiating a surface of a sample with an ultrashort laser pulse, and plasmas of different elements radiate spectral lines with different wavelengths. Elements contained in the sample can be determined based on positions of the spectral lines. In addition, spectral line intensity of an element is positively correlated with content of the element. Therefore, content of a to-be-measured element in the sample can be calculated through the positive correlation based on spectral line intensity of the to-be-measured element. However, in practical work, a measured sample includes a plurality of elements. A sum of elements other than the to-be-measured element (referred to as a matrix) inhibits or enhances the spectral line intensity of the to-be-measured element, affecting quantitative accuracy of the to-be-measured element. Apparently, due to matrix effect (inhibition or enhancement of the matrix on the spectral line intensity of the to-be-measured element), high-accuracy quantitative analysis is one of difficulties of the LIBS technology. In addition, when LIBS analysis is performed on rock/mineral, a sample needs to be ground into powder and pressed into flakes. However, this manner is difficult to implement during measurement in the field, and a speed of measurement in the field is affected.

Based on this, there is an urgent need for a technology for field quantitative analysis of lithium, which can overcome influence of matrix effect.

### SUMMARY

An objective of the present disclosure is to provide a field quantitative analysis method and system of lithium. The calibration curve corresponding to the mineral class is pre-established, the mineral class of the lithium-containing mineral is determined by the trained mineral classification model, and the content of lithium in the lithium-containing mineral is determined based on the calibration curve corresponding to the mineral class. Therefore, the lithium-containing mineral does not need to be processed, so that field quantitative analysis of lithium can be quickly performed. In addition, inference of matrix effect is suppressed, and accuracy of quantitative analysis on lithium is improved.

To achieve the above objective, the present disclosure provides the following technical solutions.

A field quantitative analysis method of lithium includes:
measuring a laser-induced breakdown spectroscopy of a lithium-containing mineral, to obtain spectral data of the lithium-containing mineral;
taking the spectral data as an input, and determining a mineral class of the lithium-containing mineral based on a trained mineral classification model; and
taking the spectral data as the input, and determining content of lithium in the lithium-containing mineral based on a calibration curve corresponding to the mineral class.

In some embodiments, before the taking the spectral data as an input, and determining a mineral class of the lithium-containing mineral based on a trained mineral classification model, the method further includes:
performing short-time Fourier transform on the spectral data, to obtain wavenumber spectrum data; and
taking modulo and log of the wavenumber spectrum data, to obtain normalized wavenumber spectrum data, and taking the normalized wavenumber spectrum data as new spectral data.

In some embodiments, a step length for short-time Fourier transform is half of a window length.

In some embodiments, the trained mineral classification model includes a feature extraction module and a classification module that are connected in sequence. The feature extraction module is configured to extract a feature vector of the spectral data. The classification module is configured to determine the mineral class based on the feature vector. The feature extraction module is a neural network model that is capable of processing time sequence data. The classification module is a multi-layer perceptron.

In some embodiments, the neural network model is a recurrent neural network. The recurrent neural network includes a plurality of neural network layers that are connected in sequence. The neural network layer is a gated recurrent unit or a transformer model.

In some embodiments, before the taking the spectral data as the input, and determining content of lithium in the lithium-containing mineral based on a calibration curve corresponding to the mineral class, the method further includes:
obtaining a plurality of lithium-containing mineral samples corresponding to the mineral class; and
for the mineral class, performing the following steps:
for each lithium-containing mineral sample corresponding to the mineral class, measuring a laser-induced breakdown spectroscopy of the lithium-containing mineral sample, to obtain sample spectral data of the lithium-containing mineral sample, and determining content of sample lithium in the lithium-containing mineral sample; and
establishing the calibration curve corresponding to the mineral class based on the sample spectral data and the content of the sample lithium in the lithium-containing mineral sample corresponding to the mineral class.

In some embodiments, the establishing a calibration curve corresponding to the mineral class specifically includes: establishing the calibration curve corresponding to the mineral class through an external calibration method, where the external calibration method includes a univariate analysis method and a multivariate analysis method.

A field quantitative analysis system of lithium includes:
a spectrum measurement module, configured to: measure a laser-induced breakdown spectroscopy of a lithium-containing mineral, to obtain spectral data of the lithium-containing mineral;
a mineral classification module, configured to: take the spectral data as an input, and determine a mineral class of the lithium-containing mineral based on a trained mineral classification model; and
a content determining module, configured to: take the spectral data as the input, and determine content of lithium in the lithium-containing mineral based on a calibration curve corresponding to the mineral class.

According to specific embodiments provided in the present disclosure, the present disclosure has the following technical effect.

The present disclosure is to provide a field quantitative analysis method and system of lithium. The laser-induced breakdown spectroscopy of the lithium-containing mineral is measured, to obtain the spectral data of the lithium-containing mineral; the spectral data is taken as an input, and the mineral class of the lithium-containing mineral is determined based on the trained mineral classification model; and the spectral data is taken as the input, and the content of lithium in the lithium-containing mineral is determined based on the calibration curve corresponding to the mineral class. In the present disclosure, the calibration curve corresponding to the mineral class is pre-established, the mineral class of the lithium-containing mineral is determined by the trained mineral classification model, and the content of lithium in the lithium-containing mineral is determined based on the calibration curve corresponding to the mineral class. Therefore, the lithium-containing mineral does not need to be processed, so that field quantitative analysis of lithium can be quickly performed. In addition, inference of matrix effect is suppressed, and accuracy of quantitative analysis on lithium is improved.

### BRIEF DESCRIPTION OF THE DRAWINGS

To describe the technical solutions in embodiments of the present disclosure or in the prior art more clearly, the accompanying drawings required for embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a flowchart of a field quantitative analysis method of lithium provided in an embodiment 1 of the present disclosure;

FIG. 2 is a schematic diagram of a structure of a recurrent neural network provided in an embodiment 1 of the present disclosure;

FIG. 3 is a schematic diagram of a structure of a gated recurrent unit provided in an embodiment 1 of the present disclosure;

FIG. 4 is a basic schematic diagram of a field quantitative analysis method of lithium provided in an embodiment 1 of the present disclosure;

FIG. 5 is a flowchart of a field quantitative analysis method of lithium provided in an embodiment 1 of the present disclosure;

FIG. 6 is a flowchart of a system for quantitative analysis provided in an embodiment 1 of the present disclosure;

FIG. 7 is a schematic diagram of a laser-induced breakdown spectroscopy of spodumene provided in an embodiment 1 of the present disclosure;

FIG. 8 is a schematic diagram of a calibration curve of spodumene provided in an embodiment 1 of the present disclosure; and

FIG. 9 is a block diagram of a field quantitative analysis system of lithium provided in an embodiment 2 of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

An objective of the present disclosure is to provide a field quantitative analysis method and system of lithium. The calibration curve corresponding to the mineral class is pre-established, the mineral class of the lithium-containing mineral is determined by the trained mineral classification model, and the content of lithium in the lithium-containing mineral is determined based on the calibration curve corresponding to the mineral class. Therefore, the lithium-containing mineral does not need to be processed, so that field quantitative analysis of lithium can be quickly performed. In addition, inference of matrix effect is suppressed, and accuracy of quantitative analysis on lithium is improved.

In order to make the above objective, features and advantages of the present disclosure clearer and more comprehensible, the present disclosure will be further described in detail below in combination with accompanying drawings and particular implementation modes.

### Embodiment 1

Spectral line intensity of an element is positively correlated with content of the element. Therefore, quantitative analysis is to inversely deduce content of an element in a sample based on the spectral line intensity of the element. Generally, a method for quantitative analysis of a laser-induced breakdown spectroscopy includes a standard analysis method and a standardless analysis method (or referred to as a calibration-free method). In the standard method, a calibration curve needs to be established, and the accuracy is high. However, applicability of the calibration curve is limited due to matrix effect. Especially, for metal minerals, there are a plurality of types of minerals, and mineral elements are distributed unevenly and rich in impurities and inclusions. Therefore, matrices are complex, and different calibration curves may need to be developed for different mining areas. In the standardless analysis method, a calibration curve does not need to be established, a mathematical model is directly established based on a physical parameter of a plasma, emission spectral line intensity, and a relationship between content of elements, and content of a corresponding elemental through the mathematical model is directly calculated based on spectral intensity. The standardless analysis method has advantages that costs are low and measurement for all elements is performed. However, the accuracy is low.

The standard method includes an external calibration method and an internal calibration method. In the external calibration method, a plurality of standard samples whose matrices are the same as a matrix of a to-be-measured sample. Content of a to-be-measured element in the standard samples is known, and the standard samples and the to-be-measured sample need to be ground into powder and then compacted. Laser-induced breakdown spectroscopies of the standard samples are first measured, to obtain spectral line intensity (that is, feature spectral line intensity) of the to-be-measured element in the standard samples. Then, a calibration curve may be obtained based on the content and the spectral line intensity of the to-be-measured element in the standard samples. Furthermore, the laser-induced breakdown spectroscopy of the to-be-measured sample is measured, and the content of the to-be-measured element is obtained through the calibration curve based on the spectral line intensity of the to-be-measured element in the to-be-measured sample. In the internal calibration method, an element that is in samples and whose content is unchanged or changed little is taken as a calibration element. Because a ratio of intensity of a spectral line of the to-be-measured element to spectral line intensity of the calibration element is positively correlated with a ratio of content of the to-be-measured element to content of the calibration element, the content of the to-be-measured element can be obtained by measuring a ratio of the spectral line intensity of the to-be-measured element to the spectral line intensity of the calibration element based on the content of the calibration element. Because influence of matrix effect on the calibration element and influence of matrix effect on the to-be-measured element are equivalent, the internal calibration method can suppress some influence of the matrix effect.

The external calibration method includes a univariate analysis method and a multivariate analysis method.

### (1) Univariate Analysis Method

In the univariate analysis method, only a relationship between the content of the to-be-measured element and the spectral line intensity of the to-be-measured element is considered, and influence of another to-be-measured element is not considered. A mathematical expression is as follows:

$$C = aI , \qquad ( 1 )$$

where

C represents the content of the to-be-measured element in the samples, a represents a proportionality constant of the to-be-measured element, and/represents the spectral line intensity of the to-be-measured element. A value of a may be determined based on values of I₁, I₂, I₃, . . . , Iₙ and C₁, C₂, C₃, . . . , Cₙ (n represents a quantity of standard samples) that are obtained through measurement in a plurality of standard samples, to obtain a calibration curve of the to-be-measured sample. An expression of the calibration curve is an equation (1). The spectral line intensity of the to-be-measured element in the to-be-measured sample into the equation (1), to calculate the content of the to-be-measured element.

### (2) Multivariate Analysis Method

In the multivariate analysis method, the spectral line intensity of the to-be-measured element is related to the content of the to-be-measured element, and related to content of another element in the samples. A mathematical expression is as follows:

$$C = {b}_{0} + {\sum }_{i = 1}^{m} {b}_{i} {I}_{i} , \qquad ( 2 )$$

where

C represents the content of the to-be-measured element in the samples, b₀ and bᵢ represent coefficients, Iᵢ represents spectral line intensity of an i^{th} element, and m represents a total quantity of selected elements. The coefficients may be determined, based on spectral line intensity and content of each element in the standard sample, through chemometrics methods such as multiple linear regression, partial least squares regression, principal component regression, or an artificial neural network, to obtain the calibration curve of the to-be-measured sample. An expression of the calibration curve is an expression (2). Spectral line intensity of a plurality of elements selected from the to-be-measured sample can be substituted into the expression (2), to obtain content of the to-be-measured element through calculation.

It can be learned that an existing quantitative method has the following shortcomings:
(1) The univariate analysis method has high requirements for the standard samples, requiring that matrix of the standard sample needs to be the same as the matrix of the to-be-measured sample. For lithium ore with complex matrices, it is difficult to effectively match the matrices of two samples, and accuracy of quantitative analysis is affected.
(2) In the multivariate analysis method, the influence of the matrix effect is considered, that is, influence of another element on the to-be-measured element. When the sample is complex and a plurality of influence factors exist, a result is unreliable. In addition, a model for the multivariate analysis method becomes quite complex, and it is difficult to obtain a common model. Therefore, requirements for a user are high during actual analysis. In the multivariate analysis method, although the neural network approach has a powerful function approximation capability and any complex nonlinear model and multidimensional data are theoretically matched based on desired accuracy, training needs to be performed with an extremely large body of data and a large amount of manpower and material resources, to achieve satisfactory accuracy.
(3) In the internal calibration method, an element whose content is unchanged or changed little is taken as a reference. Mineral components of the lithium ore are variable and it is difficult to obtain an element that meets the requirements. Therefore, this method is not applicable.

Generally, samples having simple components, such as alloys, can achieve relatively satisfactory quantitative analysis effect through an existing technology. For lithium ore having complex components, it is difficult to effectively overcome influence of complex matrices by constructing a common calibration curve for the lithium ore. Therefore, accuracy of quantitative analysis is reduced. In addition, in the existing technology, an ore sample needs to be ground and compacted. Therefore, it is difficult to perform in situ analysis in the field, efficiency is low, and costs are high. The purpose of this embodiment is to suppress influence of the complex matrices of the lithium ore, and improve accuracy of quantitative analysis. In addition, in situ analysis may be performed in the field, to improve detection efficiency.

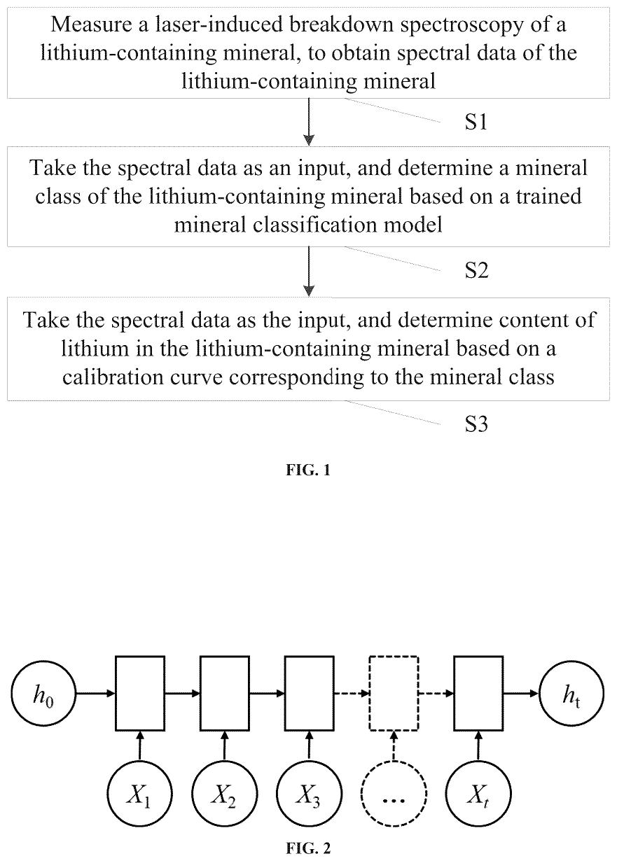

As shown in FIG. 1, specifically, this embodiment provides a field quantitative analysis method of lithium. The method includes the following steps.

S1: Measure a laser-induced breakdown spectroscopy of a lithium-containing mineral, to obtain spectral data of the lithium-containing mineral.

When the laser-induced breakdown spectroscopy is measured, measurement points are as dense as possible, and spread over a surface of the lithium-containing mineral, to obtain the spectral data of the lithium-containing mineral. The spectral data includes a plurality of sampling points, and each sampling point has a wavelength and a value of spectral intensity at the wavelength. In this embodiment, pre-processing is performed on the spectral data. Pre-processing includes elimination of background noise and correction of a spectral peak.

S2: Take the spectral data as an input, and determine a mineral class of the lithium-containing mineral based on a trained mineral classification model.

The spectral data is set to x∈R^{N}, where N represents the quantity of sampling points. More noise exists in the spectral data, and a few mineral spectra are superimposed in the noise in a form of a narrow-band pulse. To improve quality of the spectral data, in this embodiment, before S2, processing is further performed on the spectral data, to remove the noise.

To remove the noise, generally, filtering is selected. During filtering, useful information may be lost. In addition, if information between a plurality of pulses is processed through a convolutional neural network (CNN), a deep learning neural network model requires a large receptive field during processing performed on the waveform. A large quantity of trainable parameters are needed while the large receptive field is established. As a result, the deep learning neural network model is overfitting, and it is difficult to obtain high accuracy. Therefore, in this embodiment, before S2, short-time Fourier transform is performed on original spectral data. Specifically, that short-time Fourier transform is performed on original spectral data includes: performing short-time Fourier transform on the spectral data, to obtain wavenumber spectrum data, taking modulo and log of the wavenumber spectrum data, to obtain normalized wavenumber spectrum data, and taking the normalized wavenumber spectrum data as new spectral data, to perform S2. The wavenumber spectrum data includes a plurality of wavenumber spectra of different wavelengths. A quantity of wavenumber spectra is the same as a quantity of windows obtained by dividing the spectral data during short-time Fourier transform.

In this embodiment, a window length during short-time Fourier transform is 512 sampling points, and the step length (or referred to as a window step) is half of the window length, that is, the window step is 256 sampling points. When the window step is 256 sampling points, downsampling may be performed on the original spectral data, to obtain the information between a plurality of pulses, that is, to increase the receptive field.

After short-time Fourier transform is performed on the spectral data, the normalized wavenumber spectrum data is as follows:

$$X = ln ( abs ( S T F T ( x ) ) ) , \qquad ( 3 )$$

where

X presents the normalized wavenumber spectrum data; ln(·) presents a natural logarithm function; abs(·) presents a modulo taking function; STFT(·) presents a short-time Fourier transform function; and x presents the spectral data. The spectral data is converted into the normalized wavenumber spectrum data, and used to resolve a problem of an excessive difference between spectral amplitudes and implement normalization.

In this embodiment, the trained mineral classification model may include a feature extraction module and a classification module that are connected in sequence. The feature extraction module is configured to extract a feature vector of the spectral data. The classification module is configured to determine a mineral class based on the feature vector. The feature extraction module may be a neural network model capable of processing time sequence data. The classification module may be a multi-layer perceptron (MLP). Preferably, the neural network model may be a recurrent neural network (RNN). The recurrent neural network includes a plurality of neural network layers that are connected in sequence. The neural network layer is a gated recurrent unit (GRU) or a transformer model. Certainly, the neural network model may alternatively be another neural network, for example, a convolutional neural network or a long short-term memory (LSTM) network.

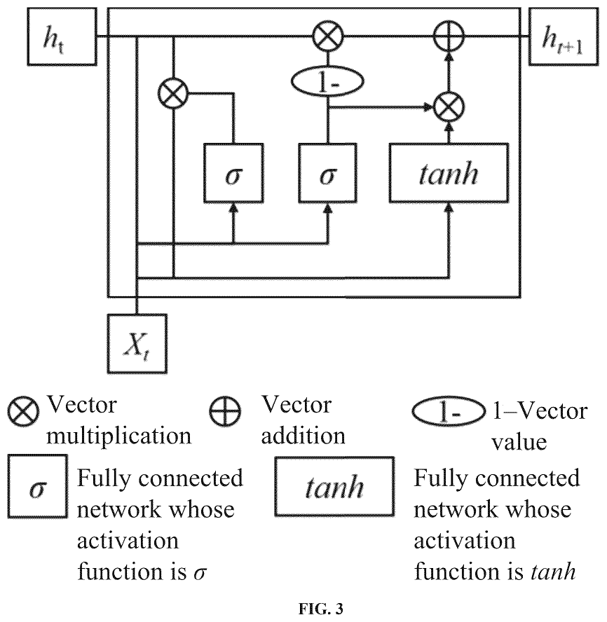

In this embodiment, feature extraction is performed on the spectral data through the recurrent neural network. A structure of the recurrent neural network is shown in FIG. 2. The recurrent neural network recursively retains information. In FIG. 2, hₜ represents a state vector, h₀ represents an initial state vector, which may be set to a value of 0, and X₁, X₂, X₃, . . . , Xₜ represent the wavenumber spectra of the different wavelengths obtained by performing short-time Fourier transform on the spectral data. FIG. 2 shows calculation of a vector and an information transfer manner, hₜ includes information of hₜ₋₁ and Xₜ, hₜ₋₁ includes information of h^{t-2} and X^{t-1}, and in this way, calculation is performed recursively. A state vector hₜ may include all pieces of information in the spectral data. Because X₁, X₂, X₃, . . . , Xₜ are input sequentially through the recurrent neural network, sequential spectral features may be processed. In comparison with simple algorithms based on short-time Fourier transform (STFT) spectra and conventional machine learning, this manner avoids loss of wavenumber spectrum features. In this embodiment, a last state vector h_{T} of the recurrent neural network is taken as the feature vector, to perform classification by the multi-layer perceptron. A calculation formula for final classification is as follows:

$$y = M L P ( {h}_{T} ) , \qquad ( 4 )$$

where

y represents a classification result; MLP represents the multi-layer perceptron; and h_{T} represents the last state vector.

In this embodiment, for neural units (that is, rectangles in FIG. 2) in the recurrent neural network, a structure of the gated recurrent unit is used. As shown in FIG. 3, in comparison with a structure of a conventional long short-term memory network, the gated recurrent unit combines a forgetting gate and an updating gate into one. Therefore, the structure of the gated recurrent unit is simple, so that a model can be more convenient to write. A calculation formula of the gated recurrent unit is as follows:

$${v}_{t} = [ {X}_{t} , {h}_{t} ] \qquad ( 5 )$$

$${g}_{1} = σ ( {v}_{t} \cdot {w}^{1} + {b}^{1} )$$

$${g}_{2} = σ ( {v}_{t} \cdot {w}^{2} + {b}^{2} )$$

$${p}_{t} = [ {X}_{t} , {g}_{1} ◦ {h}_{t} ]$$

$$q = ( {p}_{t} \cdot {w}^{3} + {b}^{3} )$$

$${h}_{t + 1} = ( 1 - {g}_{1} ) ◦ {h}_{t} + {g}_{2} ◦ q ,$$

where

vₜ represents a temporary vector during processing; Xₜ represents the wavenumber spectrum data; g₁ represents a reset gate; σ represents an S function; w¹ and b¹ represent trainable parameters of the neural network; g₂ represents the updating gate; w² and b² represent trainable parameters of the neural network; pₜ represents a temporary vector during processing; ^{o} Represents element-by-element multiplication; [ ] represents matrix connection; q represents a temporary vector during processing; tanh represents a hyperbolic tangent function; and w³ and b³ represent trainable parameters of the neural network.

When the mineral classification model is trained, in this embodiment, a cross entropy is used as a loss function. A plurality of samples are obtained in advance. Feature data of the samples is a laser-induced breakdown spectroscopy. A tag is a vector d obtained after one-hot encoding, and includes true probability that the samples belong to each mineral class. The feature data of the samples are input into the mineral classification model, to obtain an output y through calculation. The output y includes calculation probability that the samples belong to each mineral class. An e-index [e′¹, e′², L, e′^{K}] is calculated based on the output y, and a result is normalized q₁=e^{y}^{ₜ}/Σⱼ₌₁^{K}e^{y}^{ⱼ}, to convert the output y into a probability value (that is, softmax processing). Based on a tag and an output of each sample, the mineral classification model is trained with the loss function until training is complete.

The loss function is as follows:

$$loss = \frac{1}{N} {\sum }_{j}^{N} {\sum }_{i}^{K} {p}_{j , i} log \frac{1}{{q}_{j , i}} , \qquad ( 6 )$$

where

loss represents a loss value; N represents a quantity of samples; K represents a quantity of mineral classes; for pⱼ, i represents true probability that a j^{th} sample belongs to an i^{th} mineral class, and is determined based on the tag; and for qⱼ, i represents calculation probability that the j^{th} sample belongs to the i^{th} mineral class, and is determined based on the output.

In this embodiment, a training algorithm may be an adaptive moment estimation (Adam) iterative algorithm.

During use of the model, in this embodiment, the model may be encapsulated into a single interface, and inference may be completed by inputting only the vector x∈R^{N}, to obtain the mineral class. Identification of rock minerals is important for study of mineralogy. However, an occurrence state of a mineral in rocks is complex, it is difficult to manually distinguish different minerals. Especially, because some minerals have great similarity in color and morphology, it is more difficult to identify the mineral. In addition, because a radius of a laser beam of the laser-induced breakdown spectroscopy (LIBS) instrument is small (for example, 50 microns), a laser irradiation position deviates during measurement. Therefore, a measured mineral is not a target mineral, resulting in an erroneous analysis result. In contrast, in this embodiment, the mineral class is intelligently identified based on a spectral feature of the mineral, to resolve a problem of identifying the lithium-containing mineral in the field.

S3: Take the spectral data as the input, and determine content of lithium in the lithium-containing mineral based on a calibration curve corresponding to the mineral class.

Before the taking the spectral data as the input, and determining content of lithium in the lithium-containing mineral based on a calibration curve corresponding to the mineral class, the field quantitative analysis method of lithium in this embodiment further includes: obtaining a plurality of lithium-containing mineral samples corresponding to the mineral class; and for the mineral class, performing the following steps: for each lithium-containing mineral sample corresponding to the mineral class, measuring a laser-induced breakdown spectroscopy of the lithium-containing mineral sample, to obtain sample spectral data of the lithium-containing mineral sample, and determining content of sample lithium in lithium-containing mineral sample; and establishing the calibration curve corresponding to the mineral class based on the sample spectral data and the content of the sample lithium in the lithium-containing mineral sample corresponding to the mineral class, to establish a calibration curve corresponding to each mineral class.

The establishing a calibration curve corresponding to the mineral class may include: establishing the calibration curve corresponding to the mineral class through an external calibration method. The external calibration method includes a univariate analysis method and a multivariate analysis method. The univariate analysis method is used as an example. For each lithium-containing mineral sample of each mineral class, a wave peak of the sample spectral data of the lithium-containing mineral sample is taken as an abscissa, and the content of the sample lithium in the lithium-containing mineral sample is taken as an ordinate, to form a data point. Fitting is performed on all data points of the mineral class (one data point corresponds to one lithium-containing mineral sample), to obtain the calibration curve.

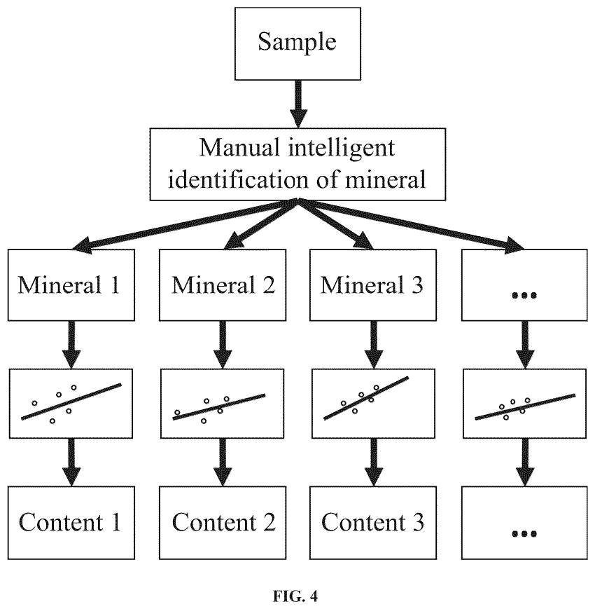

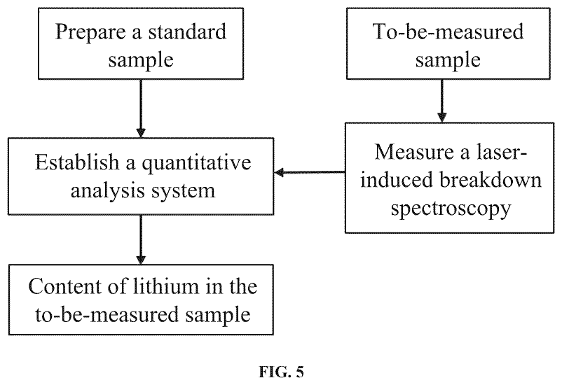

As shown in FIG. 4, a basic principle in this embodiment is as follows. Mineral identification is first performed based on a feature of a laser-induced breakdown spectroscopy of lithium ore. Actually, a mineral identification process is to classify the matrices, and perform quantitative analysis through a standard method based on different mineral classes. FIG. 5 is a flowchart based on the foregoing basic principle in this embodiment. A standard sample is prepared, wet chemical analysis is performed on the standard sample to obtain content of lithium, a laser-induced breakdown spectroscopy of the standard sample is measured, a quantitative analysis system is established based on the content of lithium and spectral data, a laser-induced breakdown spectroscopy of a to-be-measured sample is measured, and spectral data of the to-be-measured sample is input into the quantitative analysis system, to obtain a value of content of lithium in the to-be-measured sample. A specific implementation process includes the following steps.

### (1) Prepare a Standard Sample

A lithium-containing pegmatite sample is collected, and lithium-containing minerals such as spodumene, lithium mica, and tourmaline are selected, to obtain standard samples. Minerals with large crystalline forms are selected as far as possible, for facilitating measurement of the laser-induced breakdown spectroscopy. A quantity of each mineral is as large as possible, at least not less than five.

### (2) Establish a Quantitative Analysis System

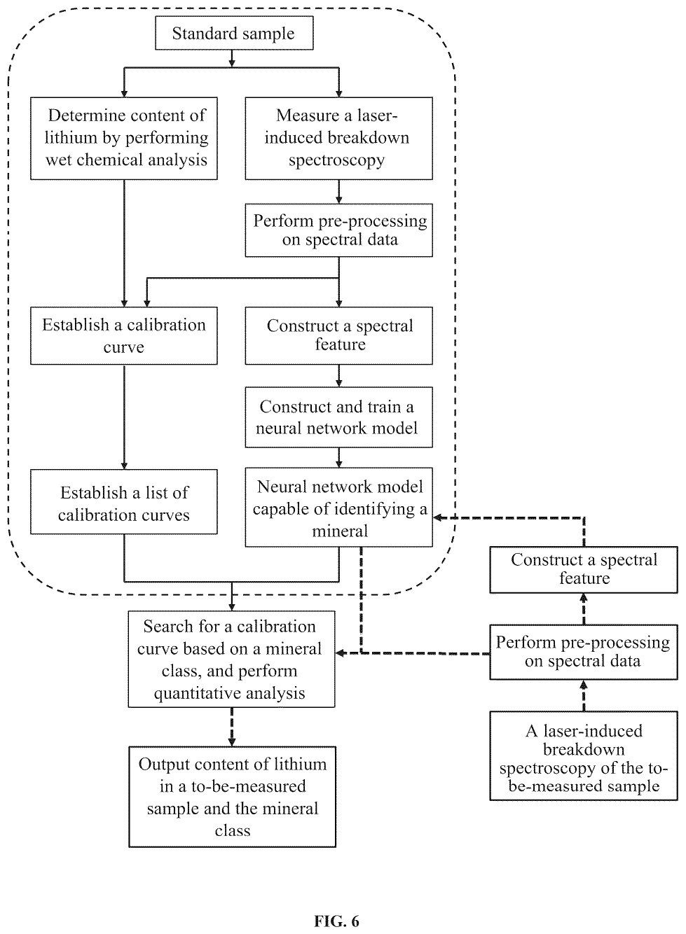

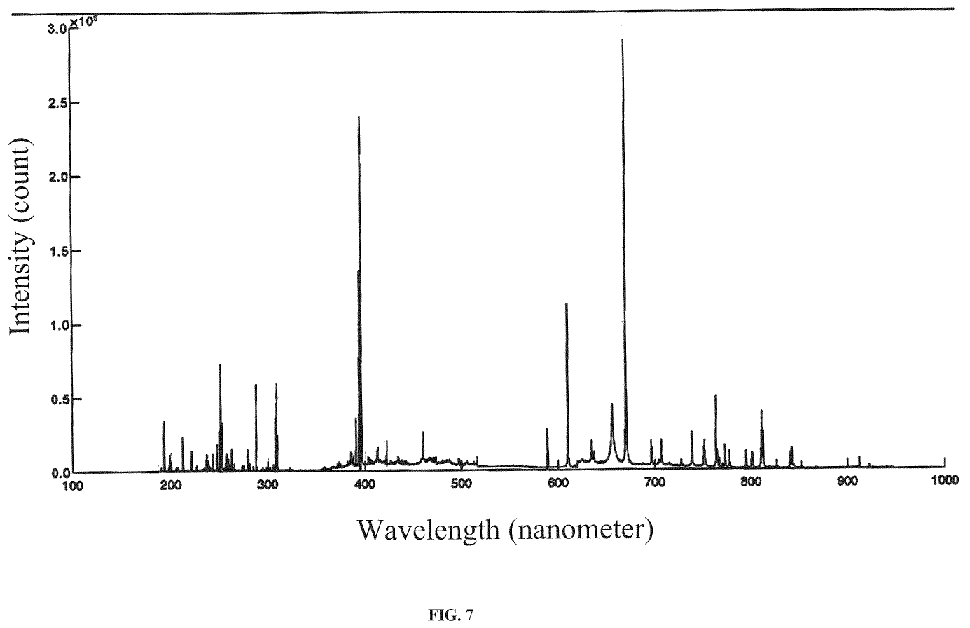

As shown in FIG. 6, the selected minerals are divided into two parts. One part is used for performing wet chemical analysis to obtain the content of lithium, and the other part is used for measurement of the laser-induced breakdown spectroscopy. During spectrum measurement, the measurement points are as dense as possible, and spread over a surface of the sample. Pre-processing is performed on the measured spectral data, for example, elimination of background noise and correction of a spectral peak. A corresponding calibration curve is established with the pre-processed spectral data of each mineral and the content of lithium obtained by performing wet chemical analysis based on the mineral class. A list of parameters of the calibration curve of the mineral. The list of parameters can be saved in a required file format, for example, excel, dat, or txt, to facilitate reading and querying.

In addition, for establishing spectral features with spectral data obtained after pre-processing, the spectral data is processed through short-time Fourier transform, and a neural network model is constructed and trained, to obtain a trained mineral classification model that can identify a mineral.

(3) Perform Quantitative Analysis on a to-be-Measured Sample

The laser-induced breakdown spectroscopy of the to-be-measured sample is measured, and pre-processing that is the same as pre-processing performed on the spectral data of the standard samples is performed on the spectral data of the to-be-measured sample. Normalization is performed on the spectral data obtained after preprocessing, mineral identification is performed on the trained mineral classification model, and the corresponding calibration curve is retrieved based on an identified mineral class. Finally, the value of lithium is obtained from the calibration curve based on spectral line intensity of a to-be-measured element in the spectral data of the to-be-measured sample. In addition, a mineral identification result is output for reference by a user.

This embodiment provides an application case herein.

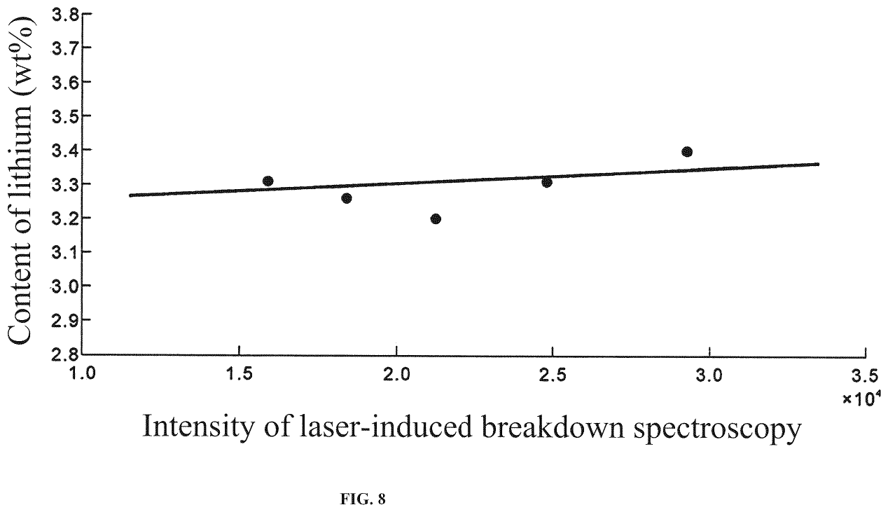

In this embodiment, pegmatite samples are collected in the Xinjiang region, 11 minerals such as spodumene, lithium feldspar, lithium mica, and tourmaline are selected from the pegmatite samples, the minerals are prepared into two sets of specimens, and each set includes 29 pieces. Wet chemical analysis is performed on one set of specimens, to obtain exact content of lithium, and 11,000 pieces of spectral data are collected from the other set of specimens through a Z-300 LIBS handheld of SciAps. FIG. 7 shows a laser-induced breakdown spectroscopy of spodumene. Positions of feature peaks of lithium are at a wavelength of 610.37 nm and a wavelength of 670.78 nm, with 670.78 nm as a main position. In this embodiment, areas of the two spectral peaks are superimposed and summed, and an obtained result is used as an intensity value of a spectral peak of lithium.

The collected spectra are divided into two parts. One part includes 9,400 pieces of spectral data and is used as a training set, and the other part includes 1,700 pieces of spectral data and is used as a validation set. An identification rate of the recurrent neural network model constructed in this embodiment on the mineral is up to 98%. On the basis of mineral identification, the calibration curve is established through the univariate analysis method in the external calibration method based on a type of the mineral, to perform quantitative analysis on lithium. FIG. 8 shows a calibration curve of spodumene. A solid line in FIG. 8 is the calibration curve of spodumene, and dots are the true positions of a to-be-measured spodumene sample in the figure. True content of the to-be-measured spodumene sample is obtained by performing wet chemical analysis, and is used to validate accuracy of a quantitative analysis result in this embodiment. Table 1 shows a result of comparison between the content of lithium in the to-be-measured spodumene sample obtained by performing wet chemical analysis and the content of lithium obtained in this embodiment. It can be seen from table 1 that, an error of the content of lithium in spodumene in this embodiment is between 0.46% and 3.42%, with an average value of 1.47%.

TABLE 1
Comparison between analysis result in this embodiment with
wet chemical analysis result

| | Content obtained by | | Content calculated |
|---|---|---|---|
| | performing wet | | in this |
| | chemical analysis | | embodiment |
| Sample | (wt %) | Error (%) | (wt %) |
| Spodumene 1 | 3.31 | 0.75% | 3.29 |
| Spodumene 2 | 3.31 | 0.46% | 3.33 |
| Spodumene 3 | 3.20 | 3.42% | 3.31 |
| Spodumene 4 | 3.26 | 1.12% | 3.30 |
| Spodumene 5 | 3.40 | 1.60% | 3.35 |

An embodiment provides a method for in situ quantitative analysis of a laser-induced breakdown spectroscopy of pegmatite-type lithium ore. The method includes: performing intelligent classification on a mineral based on a feature of a laser-induced breakdown spectroscopy of the mineral, establishing the corresponding calibration curve based on a mineral class, and performing quantitative analysis on content of an element. Therefore, lithium can be analyzed quickly in the field through a LIBS technology. In addition, influence of matrix effect can be suppressed, to improve analytical accuracy, and improve accuracy of in situ quantitative analysis of the laser-induced breakdown spectroscopy of lithium. When the mineral is intelligently identified, a spectral feature is extracted by performing short-time Fourier transform, and spectral feature data is processed through a GRU, and classification is performed through a last feature vector. Compared with a conventional technology, the field quantitative analysis method of lithium provided in this embodiment has the following advantages:
(1) In this embodiment, a uniform calibration curve of lithium does not need to be established to implement quantitative analysis. The mineral is first identified based on the spectral feature of the mineral, which actually classifies matrices. The corresponding calibration curve is established based on the feature of the mineral (that is, the matrix), which excludes influence of another matrix. This improves accuracy.
(2) In this embodiment, a result with relatively high accuracy is obtained under a condition of a small amount of samples. For a sample, there is only one value of the content of the element obtained by performing wet chemical analysis, but a plurality of pieces of spectral data can be obtained. In addition, various types of noise can be manually added to the spectral data, to simulate different test environments. Due to rich spectral data, the neural network may be trained with enough samples, to identify the mineral. However, if the neural network is constructed to directly obtain the content of the element, a large amount of samples need to be collected, and a large amount of wet chemical analysis needs to be performed, to ensure sufficient training sets, to ensure that the neural network achieves satisfactory identification accuracy. However, this consumes a large amount of time, manpower, and material resources. In this embodiment, a conventional calibration curve method based on manual intelligent identification of the mineral, which avoids performing a large amount of wet chemical analysis. Therefore, costs are saved, and efficiency is improved.
(3) In this embodiment, the mineral is identified based on the spectral feature of the mineral, which eliminates an error of manually identifying the mineral in the field. Because an occurrence state of a mineral in rocks is complex, it is difficult to manually distinguish different minerals. Especially, because some minerals have great similarity in color and morphology, it is more difficult to identify the mineral. In addition, because a radius of laser beams of a laser-induced breakdown spectroscopy (LIBS) instrument is small (for example, 50 microns), a laser irradiation position deviates during measurement. Therefore, a measured mineral is not a target mineral, resulting in an erroneous analysis result. This problem is resolved in this embodiment.

### Embodiment 2

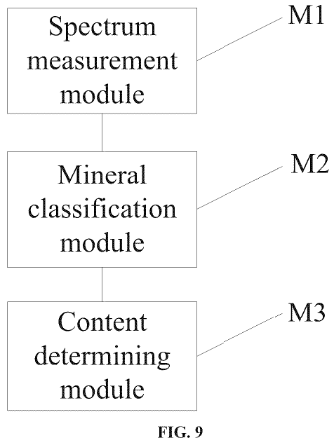

This embodiment provides a field quantitative analysis system of lithium. As shown in FIG. 9, the system includes a spectrum measurement module M1, a mineral classification module M2, and a content determining module M3. Any of the modules M1, M2, or M3 can be implemented on one or more processors, controllers, ASICs, FPGAs, or dedicated hardware. For example, any of the modules M1, M2, or M3 can be implemented as instructions that can be executed by one or more processors, controllers, ASICs, FPGAs, or dedicated hardware.

The spectrum measurement module M1 is configured to: measure a laser-induced breakdown spectroscopy of a lithium-containing mineral, to obtain spectral data of the lithium-containing mineral.

The mineral classification module M2 is configured to: take the spectral data as an input, and determine a mineral class of the lithium-containing mineral based on a trained mineral classification model.

The content determining module M3 is configured to: take the spectral data as the input, and determine content of lithium in the lithium-containing mineral based on a calibration curve corresponding to the mineral class.

Various components illustrated in the figures or described herein may be implemented as software or firmware on one or more processors, controllers, ASICs, FPGAs, or dedicated hardware. The software or firmware can include instructions stored in a non-transitory computer-readable memory. The instructions can be executed by one or more processors, controllers, ASICs, FPGAS, or dedicated hardware. Hardware components, such as controllers, processors, ASICs, FPGAs, and the like, can include logic circuitry.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A field quantitative analysis method of lithium, comprising:
measuring a laser-induced breakdown spectroscopy of a lithium-containing mineral, to obtain spectral data of the lithium-containing mineral;
taking the spectral data as an input, and determining a mineral class of the lithium-containing mineral based on a trained mineral classification model; and
taking the spectral data as the input, and determining content of lithium in the lithium-containing mineral based on a calibration curve corresponding to the mineral class.

2. The field quantitative analysis method of lithium according to claim 1, wherein before the taking the spectral data as an input, and determining a mineral class of the lithium-containing mineral based on a trained mineral classification model, the method further comprises:
performing short-time Fourier transform on the spectral data, to obtain wavenumber spectrum data; and
taking modulo and log of the wavenumber spectrum data, to obtain normalized wavenumber spectrum data, and taking the normalized wavenumber spectrum data as new spectral data.

3. The field quantitative analysis method of lithium according to claim 2, wherein a step length for short-time Fourier transform is half of a window length.

4. The field quantitative analysis method of lithium according to claim 1, wherein the trained mineral classification model comprises a feature extraction module and a classification module that are connected in sequence; the feature extraction module is configured to extract a feature vector of the spectral data; the classification module is configured to determine the mineral class based on the feature vector; the feature extraction module is a neural network model that is capable of processing time sequence data; and the classification module is a multi-layer perceptron.

5. The field quantitative analysis method of lithium according to claim 4, wherein the neural network model is a recurrent neural network; and the recurrent neural network comprises a plurality of neural network layers that are connected in sequence, and the neural network layer is a gated recurrent unit or a transformer model.

6. The field quantitative analysis method of lithium according to claim 1, wherein before the taking the spectral data as the input, and determining content of lithium in the lithium-containing mineral based on a calibration curve corresponding to the mineral class, the method further comprises:
obtaining a plurality of lithium-containing mineral samples corresponding to the mineral class; and
for the mineral class, performing the following steps:
for each lithium-containing mineral sample corresponding to the mineral class, measuring a laser-induced breakdown spectroscopy of the lithium-containing mineral sample, to obtain sample spectral data of the lithium-containing mineral sample, and determining content of sample lithium in the lithium-containing mineral sample; and
establishing the calibration curve corresponding to the mineral class based on the sample spectral data and the content of the sample lithium in the lithium-containing mineral sample corresponding to the mineral class.

7. The field quantitative analysis method of lithium according to claim 6, wherein the establishing a calibration curve corresponding to the mineral class specifically comprises: establishing the calibration curve corresponding to the mineral class through an external calibration method, wherein the external calibration method comprises a univariate analysis method and a multivariate analysis method.

8. A field quantitative analysis system of lithium, comprising:
a spectrum measurement module, configured to: measure a laser-induced breakdown spectroscopy of a lithium-containing mineral, to obtain spectral data of the lithium-containing mineral;
a mineral classification module, configured to: take the spectral data as an input, and determine a mineral class of the lithium-containing mineral based on a trained mineral classification model; and
a content determining module, configured to: take the spectral data as the input, and determine content of lithium in the lithium-containing mineral based on a calibration curve corresponding to the mineral class.
